(19) United States
(12) Patent Application Publication
(10) Pub. No.: US 2014/0019307 A1
(43) Pub. Date: Jan. 16, 2014

(54) Systems and Methods for Providing Interactive Catalogues

(71) Applicant: KipCast Corporation, Toronto (CA)

(72) Inventor: Giovanni Vito GUARDALBEN, Negrar (IT)

(21) Appl. No.: 13/936,504

(22) Filed: Jul. 8, 2013

Related U.S. Application Data
(60) Provisional application No. 61/669,810, filed on Jul. 10, 2012.

(51) Int. Cl. G06Q 30/06

(52) U.S. Cl. CPC G06Q 30/0641
USPC 705/27.1

(57) ABSTRACT

Systems and methods provide a catalogue to be displayed on an electronic device, such as a tablet computer. A catalogue server obtains data about multiple products. The data includes at least an image and text associated with each product. The data is grouped into multiple data streams, and each stream is associated with a product section of the catalogue. A page template, associated with a given data steam, and the product data are combined to form one or more page layouts. The one more page layouts and the given data stream are sent to an electronic device. The one or more page layouts and the given data stream are compiled together by the electronic device to form the catalogue section.

### CROSS-REFERENCE TO RELATED APPLICATIONS

This application claims priority from U.S. Provisional Application No. 61/669,810 filed on Jul. 10, 2012, and titled “SYSTEMS AND METHODS FOR PROVIDING INTERACTIVE CATALOGUES”, the entire contents of which are herein incorporated by reference.

### TECHNICAL FIELD

The following relates generally to providing interactive catalogues that can be viewed on an electronic device.

### DESCRIPTION OF THE RELATED ART

The Internet has provided a medium for merchants to display products and services to potential buyers, and has also provided a medium for potential buyers to purchase the products and services. Typically, a merchant can host a website that allows potential buyers to browse through products and services. This form of online shopping offers many conveniences, such as allowing a user to search for particular products.

A user can navigate a merchant's website by selecting different product categories, performing searches, or by using backward and forward buttons.

### BRIEF DESCRIPTION OF THE DRAWINGS

Example embodiments will now be described by way of example only with reference to the appended drawings wherein:

FIG. 1 is a block diagram of an example embodiment system used to provide a catalogue.

FIG. 2 is a plan view of an example embodiment electronic device.

FIG. 3 is a plan view of another example embodiment electronic device.

FIG. 4 is a block diagram illustrating example embodiment components of the system in FIG. 1.

FIG. 5 is an example embodiment page template of a certain style in portrait orientation.

FIG. 6 is an example embodiment page template of the same style as in FIG. 5, but in landscape orientation.

FIG. 7 is an example embodiment detailed description template of the same style as in FIG. 5.

FIG. 8 is an example embodiment page template of a certain style in portrait orientation.

FIG. 9 is an example embodiment page template of the same style as in FIG. 8, but in landscape orientation.

FIG. 10 is an example embodiment detailed description template of the same style as in FIG. 8.

FIG. 11 is an example embodiment of data components, including product content feed and templates, being used to form sections of a catalogue.

FIG. 12 is a flow diagram of example computer executable or processor implemented instructions for a catalogue server obtaining product content from a merchant server.

FIG. 13 is an illustration of example embodiment dictionaries.

FIG. 14 is a flow diagram of example computer executable or processor implemented instructions for a catalogue server organizing and generating product content data and a catalogue layout file.

FIG. 15 is an example embodiment of the flow of data components used to generate page layouts based on a data stream of product information and templates.

FIG. 16 is a block diagram showing an example embodiment of data components, including product ID, time stamp, page ID, and section ID, and their relationship to each other.

FIG. 17 is a flow diagram of example computer executable or processor implemented instructions for an electronic device compiling catalogue content and displaying a catalogue.

FIG. 18 is an example embodiment screen shot of a cover page of a catalogue.

FIG. 19 is an example embodiment screen shot of a page of a catalogue.

FIG. 20 is an example embodiment screen shot of another page of a catalogue.

FIG. 21 shows a series of example embodiment screen shots illustrating the user interaction for switching pages and switching sections in a catalogue.

FIG. 22 is a flow diagram of example computer executable or processor implemented instructions for switching pages based on user input to the electronic device.

FIG. 23 is a flow diagram of example computer executable or processor implemented instructions for switching sections in a catalogue based on user input to the electronic device.

FIG. 24 shows a series of example embodiment screen shots illustrating the user interaction for showing other products that are related to a given product.

FIG. 25 is a flow diagram of example computer executable or processor implemented instructions for showing related products based on user input to the electronic device.

FIG. 26 is a flow diagram of example computer executable or processor implemented instructions for the electronic device making payment or purchase.

FIG. 27 is a flow diagram of example computer executable or processor implemented instructions for updating product content in a catalogue.

FIG. 28 is a flow diagram of example computer executable or processor implemented instructions for removing product content in a catalogue.

### DETAILED DESCRIPTION

It will be appreciated that for simplicity and clarity of illustration, where considered appropriate, reference numerals may be repeated among the example figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Online shopping is becoming more popular. Users can access a merchant's website to view products and services that are for sale. A user can also select items for purchase, and make a purchase. The merchant will then have the purchased items or products mailed to the user. Such a process is also known as e-commerce.

The interface for online shopping typically includes website controls. For example, the website may have web links that, when selected, show products within a certain category (e.g. accessories, handbags, dresses, tools, shoes, suits, etc.). Search functionality may also be built into the website, allowing the user to search for certain products. It is recognized that this type of website interface may seem unnatural for many users and may seem overly complicated to use.

It is recognized that traditional paper magazines and catalogues offer a more commonly accepted experience of looking at products. For example, some users may prefer to look at a paper catalogue, which allows a user to flip through pages in a sequential manner. Another perceived benefit of a paper catalogue is that a user does not need to connect to the Internet to view products. A user can simply pick up the paper catalogue and flip through the pages to look at images of the various products and read any printed text.

As tablet computers become more widely used and common, it is recognized that the experience of a traditional paper catalogue can be produced on tablets. Tablet computers often have touch screen displays, are relatively mobile, and can be used for reading books. The flat and mobile form factor of a tablet is similar to a paper catalogue.

Digital catalogues, which display products and services for sale, can be created and displayed on a tablet computer.

Creating digital catalogues for tablet computers can be time consuming. In some cases, a designer manually builds or compiles a digital catalogue. This is then sent to a tablet computer for viewing.

Digital catalogues are typically fully compiled and built on a server-end before sending to the tablet computer for viewing by the user. For example, a fully assembled digital catalogue in PDF format or some other image document format is downloaded on to a user's tablet computer. A high number of images in the digital catalogue means that the catalogue size is large. This can cause the downloading of the digital catalogue onto the tablet computer to take a long time. This downloading time occurs every time a new digital catalogue is downloaded onto the tablet computer.

It is also recognized that some digital catalogues are Internet oriented. In other words, a computing device must connect with the Internet in order to view the digital catalogue. This can be inconvenient, since a user may prefer to view the digital catalogue without being connected to the Internet. For example, certain areas may not provide or allow Internet connectivity, and connecting to the Internet consumes power and computing resources.

It is also recognized that some digital catalogues have a collection of “pages”. In some examples, the pages are web pages. Web pages are typically programmed using HTML (hypertext markup language), although other languages can be used. The web pages are displayed in a web browser or Internet browser. Such web pages are considered to be complex and do not provide the same experience as a traditional paper catalogue.

In view of the above, it is desired to provide an interactive catalogue suitable for electronic devices, such as a tablet computer, that includes similar experience features as a traditional paper catalogue. The catalogue provided herein includes a number of catalogue sections. In an example embodiment, the catalogue sections are sequenced (e.g. in a certain order). The catalogue sections can be organized according to types of products (e.g. women's fashion, men's fashion, women's shoes, men's shoes, children's fashion, home furnishings, tools, equipment, etc.), or by brand names, or by pricing, or by merchants, or other factors. Each catalogue section includes one or more pages, each page having a predetermined number of products on display. In an example embodiment, the pages in each section are sequenced (e.g. in a certain order).

In an example embodiment, a proposed method performed by a computing device for providing a catalogue, includes obtaining data about multiple products. The data includes at least an image and text associated with each product. The data is grouped into multiple data streams, and each stream is associated with a product section of the catalogue. The computing device identifies a page template associated with a given data stream. The computing device then creates one or more page layouts by assigning the data of each product, from the given data stream, into certain positions in the page template. The one more page layouts and the given data stream are then sent or provided to an electronic device, such as a tablet computer. The one or more page layouts and the given data stream can be compiled together by the electronic device to form one or more compiled pages of a given product section of the catalogue.

In another example embodiment, a proposed method performed by an electronic device for providing a catalogue, includes obtaining one more page layouts and an associated data stream. This data can be obtained from the computing device. To obtain all the sections of a catalogue, the electronic device obtains page layouts and associated data stream for every section of the catalogue. For a given section, the one or more page layouts include instructions to display certain images and text in certain locations on each page. The images and text are from the associated data stream. The electronic device then compiles the catalogue section of one or more pages by using the one or more page layouts and associated data stream. The electronic device then displays the one or more pages on a display screen.

It can be appreciated that the page templates allow the individual pages of the catalogue to be easily and automatically created. Therefore, the product data can be in various formats and may not even be organized in any particular way. However, the computing device, herein referred to as the catalogue server, can automatically organize and group the product data. The catalogue server can automatically generate page layouts using the templates and the grouped product data. In other words, the process for creating a catalogue is much quicker and uses less time and effort, or none at all, from a person (e.g. digital catalogue creator).

In an example embodiment, the catalogue is not completely compiled or formed by the catalogue server, but instead the data stream and the page layouts are sent to the electronic device for compiling. In other words, the term “page layout” refers to a file of instructions that specifies the organization and positioning of specified data elements for a page, but does not include the actual data elements. The specified data elements are specifically identified by name or some other data identification. The data elements are obtained from the data stream. The term “page” or “compiled page” refers to an electronic page in a catalogue that arranges the specified data elements according to the page layout. In other words, a page or a compiled page has the data elements “filled” into a page, based on the page layout. The page or compiled page is ready for display on a user's electronic device.

The approach of sending the page layouts and the data streams can reduce the data file size of the catalogue being sent to the electronic device, and thus, also reduces the time for downloading the catalogue. For example, an entirely compiled catalogue can have a larger data size than a combination of the page layouts and the data streams. Sending the page layouts and data streams separately to the electronic device also allows certain sections of the catalogue to be updated without affecting other sections. This flexibility means that if a new section of the catalogue is available, or an existing section of the catalogue is revised, the entire catalogue does not need to be sent to the electronic device; only the relevant section is sent to the electronic device for compiling.

In an example embodiment, a separate software application on the electronic device is used to display the data. The software application, herein referred to as the catalogue application, uses a network connection, such as the Internet, to download or obtain the page layouts and the data. After this information is obtained and stored on the electronic device, it no longer needs the network connection. The electronic device can compile the information to create the interactive catalogue. A user can flip through all the pages of the catalogue on the electronic device without connecting to the Internet.

In an example embodiment, the catalogue application also provides a graphical user interface (GUI) that detects touch gestures for flipping through pages and jumping to different catalogue sections. The user experience becomes very much like a traditional paper catalogue, and in some aspects is made more convenient than a traditional paper catalogue.

In an example embodiment, the proposed systems and methods also provide an approach for converting an e-commerce website to an m-commerce catalogue experience. M-commerce is also referred to as mobile commerce. The catalogue server can obtain e-commerce data from a merchant's e-commerce website. Using the systems and methods described herein, the data from the e-commerce website is used to create the pages of the catalogue, which are displayed on the electronic device.

The above features, as well as other features, are described in further detail with respect to the figures.

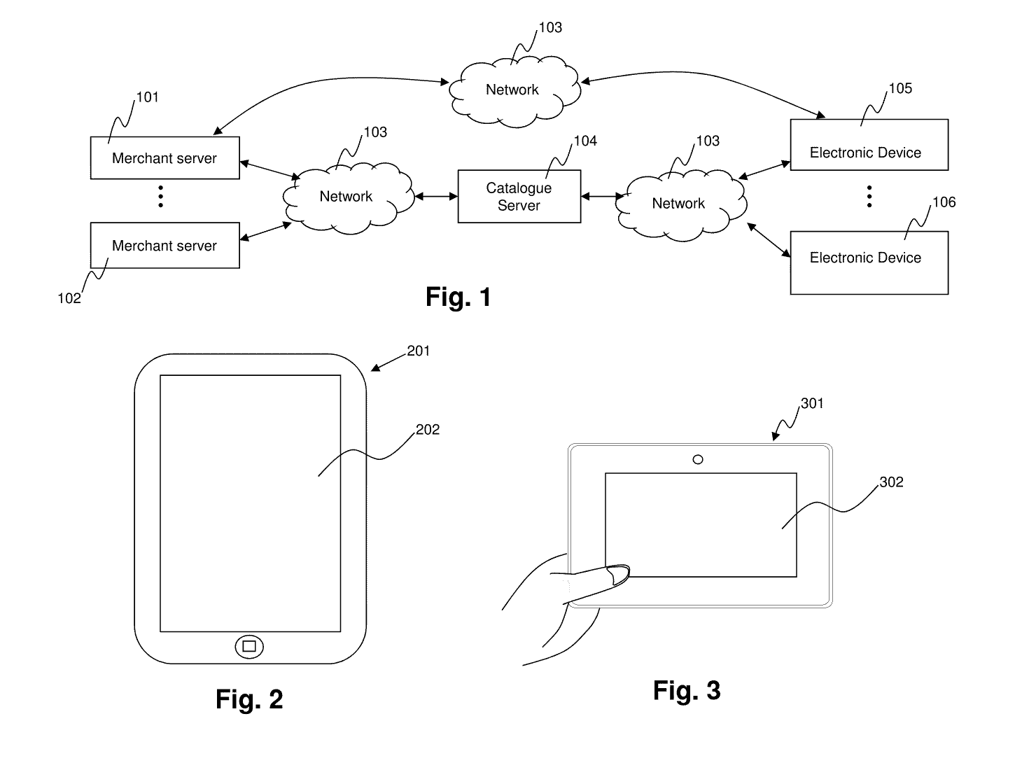

Turning to FIG. 1, an example embodiment of a system for providing interactive catalogues is shown. One or more merchant servers 101, 102 are in data communication with a catalogue server 104 over a network 103. The catalogue server 103 is in communication with one more electronic devices 105, 106 over the network 103. An electronic device 101 can also communicate with a merchant server 101 over the network 103.

The network 103 can be any one of, or combination of, an Internet network, a cell-phone network, a LAN network, and a wireless network. Other data communication networks can be used. In many cases, an Internet network is used because of its widespread availability.

A merchant server 101 is a computing device, including processor and memory components, that stores product data. Product data includes images and text describing a product. The merchant server 101 can also host an e-commerce website for selling the products.

The catalogue server 104, including processor and memory components, is another computing device that obtains the product data and generates catalogue content. Catalogue content includes page layouts and product data assigned to the page layouts.

The electronic device 105 includes processor and memory components, and is able to compile the catalogue content to form a catalogue for display. In the case of many electronic devices, the electronic device includes a display screen or display device.

It can be appreciated that various electronic devices can be used with the example embodiments described herein. Examples of applicable electronic devices include pagers, tablets, cellular phones, cellular smart-phones, wireless organizers, personal digital assistants, computers, laptops, handheld wireless communication devices, wirelessly enabled notebook computers, camera devices and the like. Such devices will hereinafter be commonly referred to as “mobile devices” for the sake of clarity. It will however be appreciated that the example embodiments described herein are also suitable for other devices, e.g. “non-mobile” devices. The non-mobile devices may include, for example, a desktop computer. More generally, both non-mobile and mobile devices are referred to as “electronic devices”. Such terms can be interchangeable.

Example embodiments of tablets are shown in FIG. 2 and FIG. 3. In FIG. 2, the tablet 201 includes a touch-sensitive display screen 202. In FIG. 3, the tablet 301 includes a touch-sensitive display screen 302. Other tablets and electronic devices can be used.

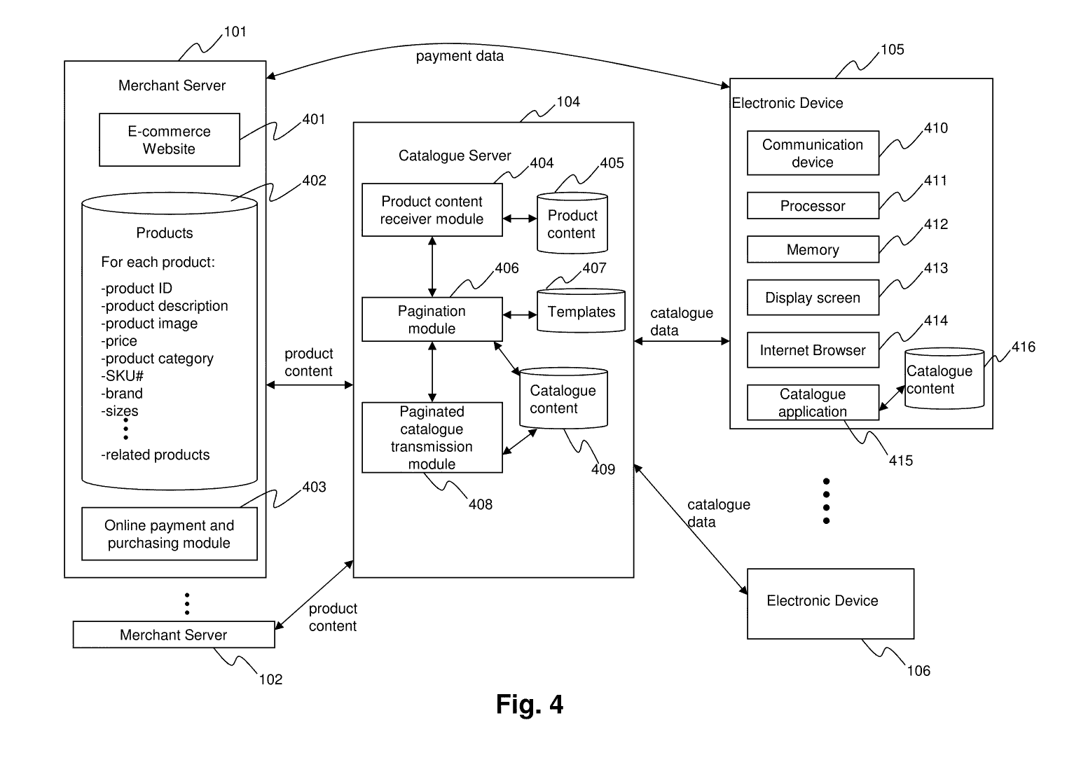

Turning to FIG. 4, an example embodiment shows the data components involved in providing a catalogue. The merchant server 101 has a database 402 storing product data or product content. Each product is associated with a number of different types of data. Non-limiting examples of such data include: a product ID, a product description, a product image, a price, a sale price, an original price, a product category, a SKU (stock-keeping unit) number, a brand, a size of the product (e.g. for clothing, shoes, accessories, tools, etc.), and any related products. The related products can be identified by name, product ID, SKU number, etc. In an example embodiment, the product ID is the SKU number.

The merchant server 101 can also include an e-commerce website 401 for displaying and selling the products. The merchant server 101 can also include an online payment and purchasing module 403 for facilitating the payment and purchasing of products.

It is appreciated that different merchants, and their merchant servers, can be connected to the catalogue server 104.

The merchant server 101 sends product content to the catalogue server 104. In an example embodiment, the catalogue server 104 extracts (e.g. also referred to as crawling or scraping) the e-commerce website 401 for the product content. The catalogue server 104 then organizes the product content into data streams based on catalogue sections.

In another example embodiment, the merchant server 101 pushes the product content to the catalogue server 104. In an example embodiment, the product content provided by the merchant server 101 to the catalogue server 104 is already organized into streams of data. In another example embodiment, the product content provided by the merchant server 101 is not organized, and the catalogue server, after receipt, organizes the product content into data streams based on catalogue sections.

It can be appreciated that there are various ways for the catalogue server 104 to obtain or receive product content. The catalogue server 104 includes a product content and receiver module 404 which implements and manages the receipt of the product content. The module 404 also is configured to organize or group the data into data streams for different catalogue sections. A database 405 stores the product content. In an example embodiment, the database 405 stores the product content in an unorganized format. In another example embodiment, the database 405 stores product content in an organized format, which includes data streams corresponding to respective catalogue sections.

A pagination module 406 uses the data streams and page templates to create pages for a given catalogue section. The page templates are stored in a templates database 407. In particular, for a given catalogue section, the pagination module 406 identifies a page template for the given catalogue section. The module 406 then assigns product data from the data stream (of the given catalogue section) to be displayed in certain positions in the page template. This assignment of product data and page template forms one or more page layouts. The page layout and the corresponding data stream form catalogue content, which is stored on the catalogue content database 409.

The paginated format of the catalogue content is then sent, using the paginated catalogue transmission module 408, to the electronic device 105.

Continuing with FIG. 4, the electronic device 105 includes a communication device 410. For example, it can include a modem, a wireless radio suitable for communicating over a cellular network, Bluetooth, a WiFi radio, or any other currently known or future known communication devices.

In an example embodiment, the electronic device is configured to communicate with the network in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the example embodiments described herein are intended to use any other suitable standards that are developed in the future. In an example embodiment, the wireless link connecting the communication module with the network represents one or more different Radio Frequency (RF) channels, operating according to defined protocols specified for GSM/GPRS communications.

The electronic device 105 also includes a processor 411, an Internet browser 414, and memory 412. The electronic device is either connected to a display screen 413 or includes a display screen. For example, tablets, laptops, and mobile devices are electronic devices that are integrated with a display screen. Other devices for displaying graphics and user interfaces can be used.

In an example embodiment, the display screen 413 is a touch-sensitive display screen.

The electronic device 105 includes a catalogue application 415 which compiles the catalogue and displays the pages of the catalogue. The electronic device 105 receives catalogue data from the catalogue server 104 and stores it on a catalogue content database 416 on the electronic device 105.

In an example embodiment, the data streams of the product content or data are in transmitted in an RSS (really simple syndication) format. The corresponding page layouts may also be transmitted in an RSS format. In an example embodiment, the page layout file and the corresponding data stream file have “.xml” formats. RSS is a content-oriented standard for content delivery that is well known, robust and simple. XML is “the” protocol per excellence for data transfer operations. An alternative protocol (conceptually similar) is JSON. In other example embodiments, other currently known or future known protocols may be used.

Continuing with FIG. 4, if a user wishes to make a purchase of a product shown in the catalogue, the electronic device, through its catalogue application 415, will display a payment GUI that will collect the user's payment information (e.g. name, credit card number, banking number, etc.). In an example embodiment, the electronic device 105 will then connect with the merchant server 101 and send the payment data and purchasing data to the merchant server 101. The merchant server 101 uses this data to execute the transaction using e-commerce methods. It can be appreciated that from the user's perspective, the experience of the catalogue application is maintained even when making payment and the Internet browser does not need to be viewed or used by the user.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the merchant server 101, catalogue server 104, or electronic device 105, or accessible or connectable thereto. Any application or module herein described may be implemented using computer readable/executable instructions or operations that may be stored or otherwise held by such computer readable media.

It will be appreciated that a number of the operations and methods described herein are within the context of GUIs, and that the operations and methods related to the GUIs include computer executable or processor implemented instructions. The computer executable or processor implemented instructions in some cases are shown, and in other cases, are not shown, in the context of flow diagrams.

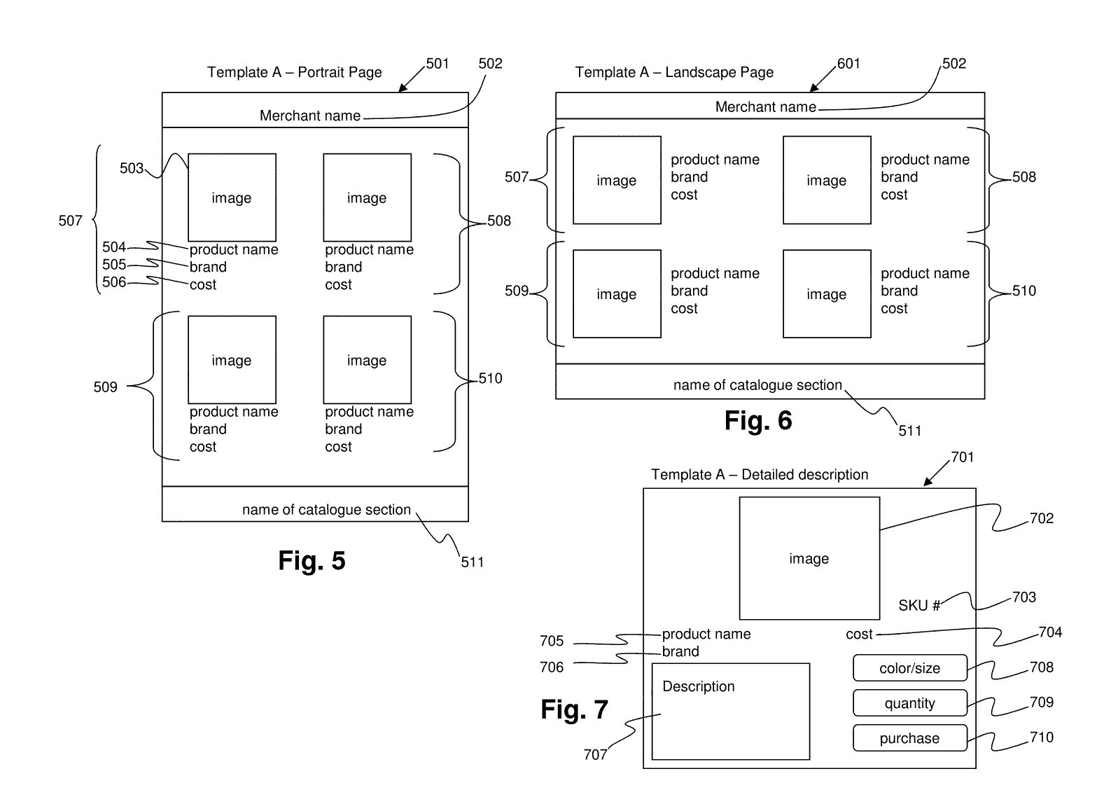

FIG. 5 to FIG. 10 show example embodiments of templates stored on the templates database 407.

A template is a generic organization and layout of information that can be used to form a page in a section of the catalogue. Certain types of product data (e.g. product image, price, product name, etc.) are positioned in a page according to the template. The same template can be re-used to form multiple pages, each page containing different product content.

Different styles of page templates are provided. Typically, a designer (e.g. a person) designs the page templates. These are then stored in the database 407. Different styles of page templates can be used for different catalogue sections.

In an example embodiment, a page template in a portrait orientation and a corresponding page template in a landscape orientation are provided. This is to account for electronic devices, such as tablets, that can be oriented in a portrait orientation or a landscape orientation. Therefore, when the tablet is in a portrait orientation, the portrait page is displayed. When the tablet is in a landscape orientation, the corresponding landscape page is displayed. Although the portrait or landscape layout changes, the product content on the page remains the same.

In another example embodiment, there is only one orientation of a page template that is provided and used.

Turning to FIG. 5, a page template 501 is shown. It is called “Template A—Portrait Page”, since it is configured for a portrait orientation. At the top of the template 501, a merchant name 502 is to be inserted. The merchant name is provided by the merchant server 101. The template 501 has four product slots, 507, 508, 509, 510. Each product slot is able to receive data that displays information about a product. Any product can be displayed within a slot. In other words, if the template 501 is used to generate a page layout, such a page layout can only display up to four products on a page. In FIG. 5, the product slot 507 includes an area for displaying an image 503 of the product, a text field 504 for displaying the product name, a text field 505 for displaying the brand of the product, and a text field 506 for displaying the cost or price of the product. The other slots 508, 509, and 510 include the same image displays and text fields. The bottom of the template 501 shows the name of the catalogue section 511.

Turning to FIG. 6, the same template style “Template A” as template 501 is shown, but is configured for a landscape orientation. The template 601 is therefore called “Template A—Landscape Page”. The template 601 also has four product slots 507, 508, 509, 510. The information associated with each slot is the same as discussed in FIG. 5, although the arrangement and positioning of the information is better suited for a landscape page. The merchant name 502 and the name of the catalogue section 511 is also shown on the template 601.

It can be appreciated that both templates 501 and 601 can be used to show the same information, but in either the portrait or landscape orientations.

Template 701 shows a detailed description page of a particular product. For example, if a user selects a certain product on page in the catalogue, a detailed description page of the certain product is shown. An example detailed description page template is template 701 and has the template style “Template A” corresponding to templates 501 and 601. The detailed description template 701 includes a larger sized image 702 of the certain product, the product name 705, the brand 706, the costs 704, the SKU number 703, and a more detailed description of the product 707. There may also be a user control 708 for viewing the different colors or sizes, or both, of the product. There may be a user control 709 for selecting a quantity of the product for purchasing. There is also a user control 710 to initiate payment and purchase of the selected product.

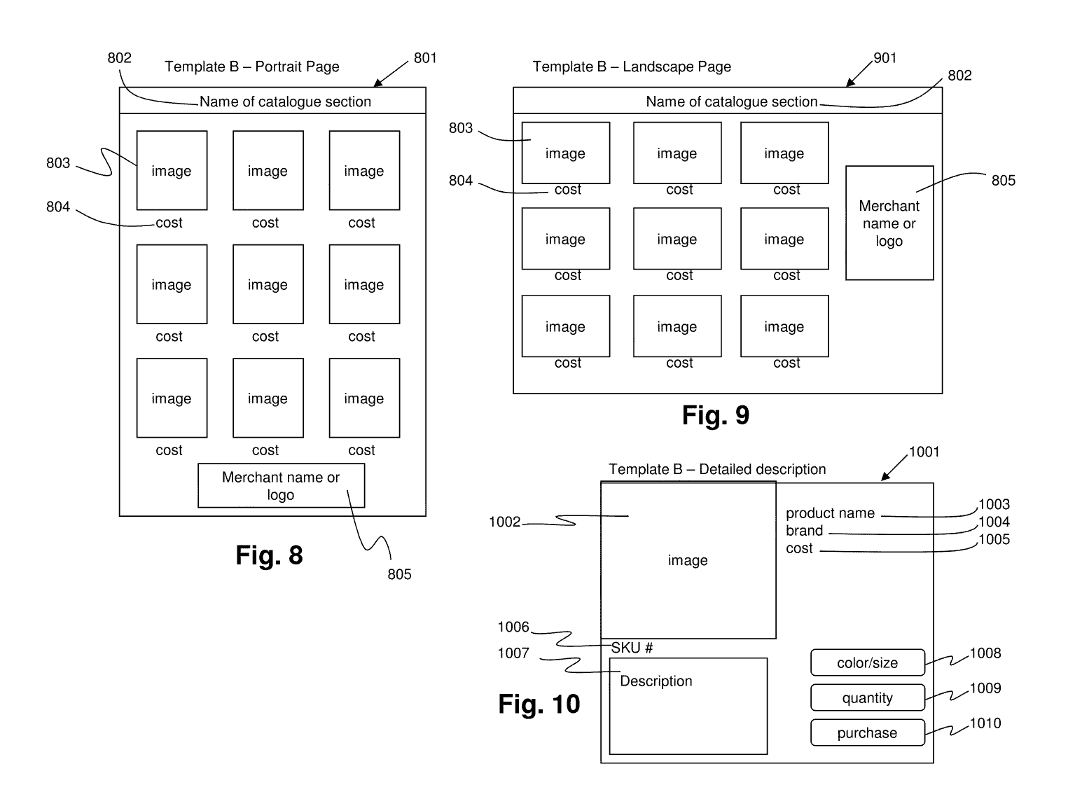

FIG. 8, FIG. 9 and FIG. 10 show a different template style, referred to as “Template B”. Turning to FIG. 8, a template 801 for portrait orientation is shown. It includes the name of the catalogue section 802 and the top of the page and the name or logo of the merchant 805 at the bottom of the page. There are nine product slots on the page template 801. Each product slot shows an image 803 of the product and a cost 804.

In FIG. 9, the corresponding landscape page template 901 is shown. It also includes nine product slots, each showing an image 803 and cost 804 of the product. The name of the catalogue section 802 is shown at the top of the template 901, and the merchant name or logo 804 is shown at the side of template 901.

In FIG. 10, a detailed description template page 1001 of the same template style “Template B” is shown. Such template page 1001 is used when one of the products in the catalogue is selected. It includes an area for a large image 1002 of the product, a product name 1003, a brand 1004, a cost 1005, a SKU number 1006, and a product description 1007. There are also user controls provided for selecting colors/sizes 1008 and the quantity 1009, and for initiating purchase 1010 of the product.

Each template has associated therewith certain text fonts, image sizes, etc. In other words, when the product information (e.g. product image, costs, product name, catalogue section, merchant name, etc.) is provided, this information is used to “fill-in” or populate the template, thereby creating pages or page layouts.

It can be appreciated that other templates, having different styles and information, can be used.

In an example embodiment, the systems and methods proposed herein do not use dynamic reformatting. The templates are configured to be used specifically with identified electronic device hardware for optimal rendering.

In an example embodiment, a page rendering language (e.g. XML) is used with the templates to generate page layouts that precisely position the content for good rendering. It is noted that HTML is not a page rendering language but a page command language.

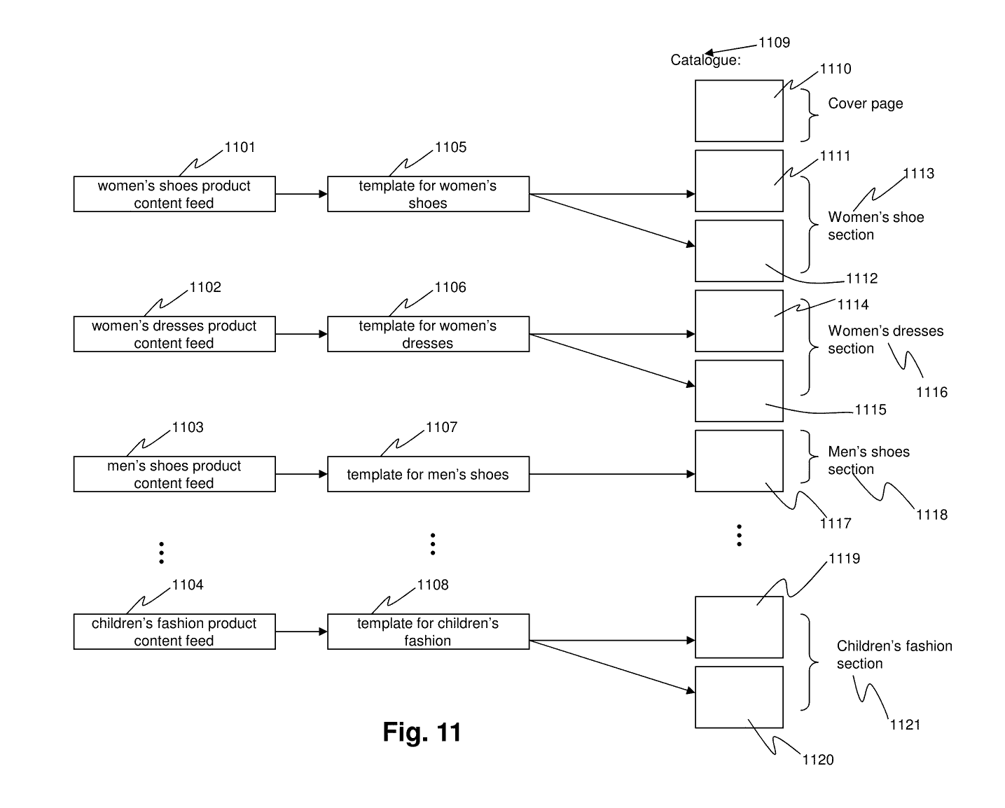

Turning to FIG. 11, an example embodiment shows the organization and types of data used to create a catalogue. The catalogue server 104 obtains or generates data streams. Each data stream corresponds to a separate catalogue section. A data stream can also be referred to as a product content feed, for example, in the format of an RSS feed.

There may be a women's shoes product content feed 1101, which includes product data about various women's shoes. There may be a women's dresses product content feed 1102, which includes product data about different women's dresses. There may be a men's shoes product content feed 1103, which includes product data about different men's shoes. There may be a children's fashion product content feed 1101, which includes product data about different children's fashion.

When the catalogue server obtains the women's shoes product content feed 1101, it identifies the one or more templates 1105 (e.g. portrait, landscape, detailed product description, etc.) that are to be used for displaying the women's shoes. In an example embodiment, there is a template 1105 that is specifically designed from the women's shoes. In an example embodiment, each women's shoe from the feed 1101 is assigned to a slot in the template 1105. For example, if the template 1105 has four product slots, and there are eight women's shoes in the content feed 1101, then two page layouts 1111 and 1112 are created. The page layouts 1111 and 1112 have the same template layout 1105, but each page layout has assigned to it different women's shoes. Together, the two page layouts 1111 and 1112 make up the women's shoes section 1113 of the catalogue 1109. When an electronic device 104 compiles the data stream, or content feed, with the page layouts 1111 and 1112, two pages showing women's shoes are created for the women's shoe section 1113.

Similarly, the women's dresses product content feed 1102, or information associated therewith, is used to identify a template for women's dresses 1106. The template 1106 and the product information from the feed 1102 are used to generate page layouts 1114 and 1115 for the women's dresses section 1116. In this example embodiment, two page layouts are generated, although any number of page layouts can be generated. The number of page layouts depends on the template style (e.g. how many product slots are in a template) and how many products there are in a data stream (e.g. product content feed).

The men's shoes product content feed 1103, or information associated therewith, is used to identify a template for men's shoes 1107. The template 1107 and the product content feed 1103 are used to generate a page layout 1117 for the men's shoe section 1118.

The children's fashion product content feed 1104, or information associated therewith, is used to identify a template for children's fashion 1108. The template 1108 and the product content feed 1104 are used to generate page layouts 1119 and 1120 for the children's fashion section 1121.

One or more pages make up each catalogue section. The different catalogue sections 1113, 1116, 1118, 1121 make up the catalogue 1109. The sections are arranged in a certain order. There may also be a cover page 1110 put at the front of the catalogue 1109.

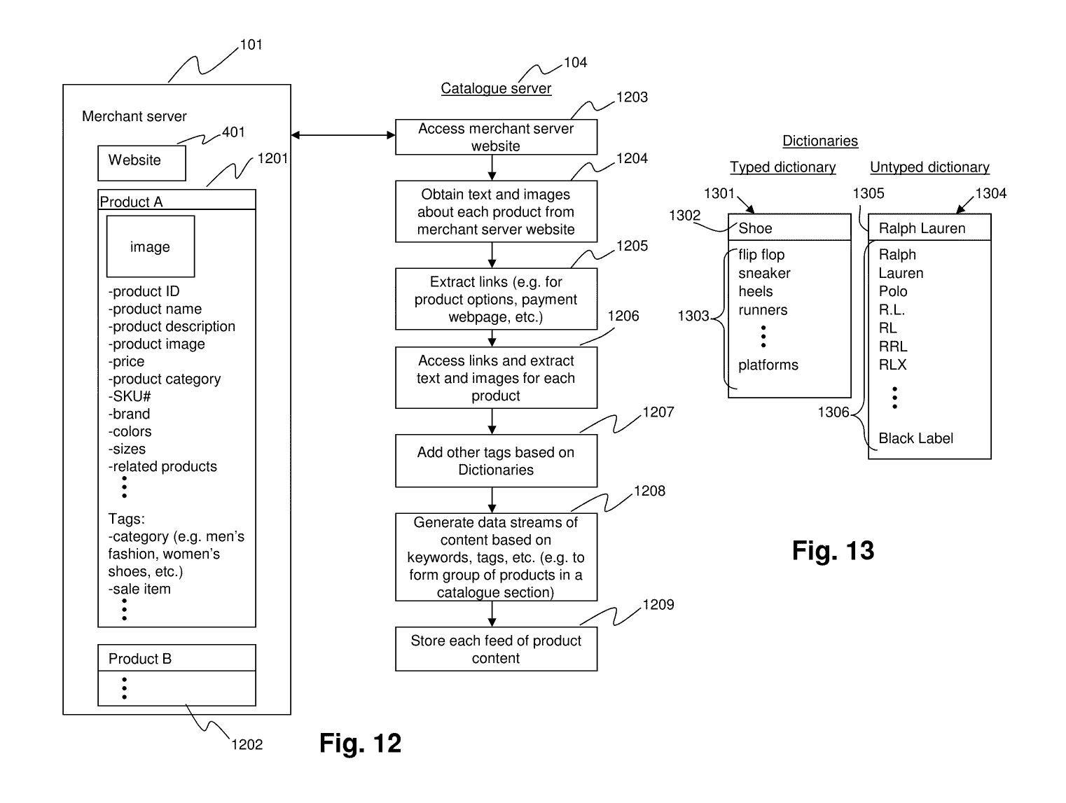

Turning to FIG. 12, example computer executable or processor implemented instructions are provided for a catalogue server 104 obtaining product content. The merchant server 101 hosts a website 401 which provides product information. Associated with each product, for example product A 1201, is product data, including an image file of the product, product ID, product name, brand, price, sizes, colors, related products, product category, etc. This information may be used as tags to characterize the product. In an example embodiment, the product data includes specific tags, such as a product category. Examples of category or section tags include: men's fashion, women's shoes, tools, etc. Another tag may specify whether the product is a sale item. Such information is also specified for other products, such as product B 1202, on the merchant server 401.

The catalogue server accesses the merchant server website (block 1203), for example, over the network connection 103. The catalogue server obtains text and images about each product from the merchant server website (block 1204). Various web scraping or web harvesting techniques can be used. The catalogue server may also extract web links from the website 401 (block 1205). The web links may lead to different product options, a more detailed description of the product, a payment web page, etc. The catalogue server accesses the web pages using the web links, and extracts additional text and images for each product (block 1206).

In an example embodiment, the product content receiver module 404 functions as a content aggregator and can include a feedbot list (not shown). The module 404 collects content through the network 103 and stores them into the product content database 405. The feedbot list includes different feedbots, wherein each feedbot contains the address or location of merchant server websites on the network 103. The module 404 collects content through the network 103 based on the addresses or locations provided by the feedbot list. The module 404 also converts non-RSS data, for example HTML data from websites, into an RSS format. The conversion of non-RSS data to RSS data can be implemented using scripting languages, for example Groovy scripting, which allows the conversion to occur automatically without interrupting the aggregation of content. It can be appreciated that the use of scripting mitigates the need to use a daemon, which is a software that runs in the background rather than under the direct control of the user, because scripting can be dynamically modified without restarting the daemon. In an example embodiment, the module 404 obtains the non-RSS data and converts it to RSS data, before storing the RSS data into the product content database 405. In another example embodiment, the module 405 stores the non-RSS data into the database 405, and then converts the stored non-RSS data into RSS data, and saves the RSS data in the database 405 in place of (or in addition to) the non-RSS data. Using RSS data in the context of the catalogue server can be advantageous because RSS data can be queried by the pagination module 406 to extract all the products that fit into an individual catalogue page.

Continuing with FIG. 12, the catalogue server may add other tags based on Dictionaries (block 1207). The dictionaries are listings of words and phrases that have been grouped together under a common meaning. These groupings of words are used as tags to add further meaning to the collected content. This semantically enriches the extracted text. The catalogue server can use the dictionaries to determine the context and meaning of certain words. Dictionaries may include typed dictionaries and untyped dictionaries. Typed dictionaries include words or phrases that are grouped under a heading based on a perceived relationship between each of the words or each of the phrases to the heading. The perceived relationship is determined by an administrator of the catalogue server 104, or by an end user at the electronic device 105, or both. Generally, the perceived relationship in typed dictionaries are more general and broad.

In untyped dictionaries, there is a header, also referred to as the entity or target tag. A series of words that are each synonymous, in a general sense, with the target tag are also included in the untyped dictionary.

In a general example embodiment, when a word is found in the text of product (e.g. product description, product name, product brand, etc.) and the word matches any one of a plurality of words grouped together under a heading, wherein each one of the plurality of words is associated with the heading, then the heading is added as a tag to the product.

Turning briefly to FIG. 13, an example of a typed dictionary 1301 is shown having the header “shoe” 1302. In a list of words 1303 (e.g. flip flop, sneaker, heels, runners, clogs, platforms, etc.), each word is associated with the header. If one of the words 1303 from the dictionary 1031 is found in the text associated with a product, then the tag “shoe” is added to the product. An example of an untyped dictionary 1304 is shown, having a header “Ralph Lauren” 1305. A series of synonymous words 1306, in a general sense, include for example: Ralph, Lauren, Polo, R.L., RL, RRL, RLX, and Black Label. If one of the words 1306 from the dictionary 1304 is found in the text associated with a product, then the tag “Ralph Lauren” is added to the product.

Turning back to FIG. 12, data streams of content are generated based on the keywords and tags associated with each product. For example, for all products that have the keywords or tags “men” and “shoes”, these products are grouped together to form a data stream for the men's shoes catalogue section. In an example embodiment, data streams are generated on the fly based on the catalogue server query language that supports all above filtering operations on the stored data from the merchant server.

Each data stream, or product content feed, is stored in the database 405 (block 1209).

In another example embodiment, the product content is provided by the merchant server 101 to the catalogue server 104 in already organized data streams, each data stream specific to a catalogue section.

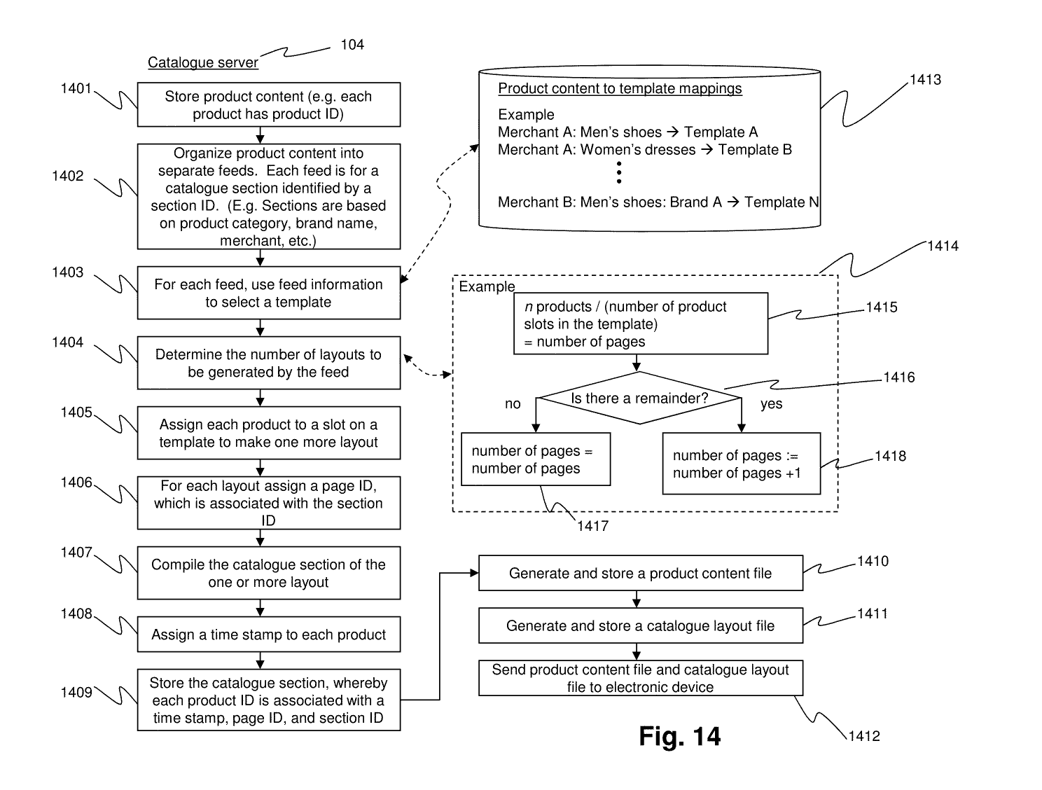

Turning to FIG. 14, an example embodiment of computer executable or processor implemented instructions is shown for providing a catalogue. The catalogue server stores the product content (block 1401). The catalogue server organizes the product content into separate data streams (or feeds) (block 1402). Each data stream is identified by a section ID. Sections can be based on product category, brand name, merchant, or other factors.

Blocks 1401 and 1402 are performed if the product content has not already been organized into data streams. It can be appreciated that the term “data stream” and “feed” can be used interchangeably.

For each data stream, the data stream information is used to select a template (block 1403). For example, there may be a database 1413 on the catalogue server 104 that maps product content to templates. An example mapping specifies that men' shoes from Merchant A are to be displayed using Template A. Another example mapping specifies that women's dresses from Merchant A are to be displayed using Template B. Another example mapping specifies that men's shoes from Merchant B are to be displayed using Template N.

In a general example embodiment, the catalogue server searches a database of predetermined mapping rules, which each rule mapping data stream information (e.g. product category, merchant, brand, etc.) to a certain page template. For a given data stream, if the server determines that a predetermined mapping applies to the given data stream, when the data stream information of the predetermined mapping matches data stream information of the given data stream, then the server identifies that the page template from the mapping is associated with the given data stream.

In an example embodiment, multiple feeds can be applied to a given template to mix and match products belonging to different categories.

The catalogue server determines the number of page layouts to be generated using the data stream and the selected template (block 1404). An example for computing the number of pages is shown in block 1414. The number of products in a data stream is represented by n, and this number is divided by the number product slots in the selected template. The quotient provides the number of pages (block 1415). It is then determined if there is a remainder from the division computation (block 1416). If so, the number of pages is incremented by one (block 1418). If there is no remainder, the number of pages remains unchanged (block 1417).

After determining the number of page layouts to be generated, the catalogue server assigns each product in the data stream to a slot on the template (block 1405). The template is re-used as many times as there are page layouts. For each page layout, the catalogue server assign a page ID which is also associated with the section ID (block 1406). The catalogue server compiles or groups the one or more page layouts to form the catalogue section (block 1407).

A time stamp is also assigned to each product (block 1408). In an example embodiment, a timestamp is assigned to each product when feeds and templates are combined.

In an example embodiment, a new timestamp is assigned only if there is no corresponding product in a previous processing phase. “Corresponding product” herein refers to the same hash value of the concatenated text of all fields of a product. The previous processing phase includes the catalogue server comparing the output of each pagination operation as generated by the pagination module 406. In an example embodiment, the pagination module 406 operates on a continuous basis to keep the catalogue content 409 repository synchronized with products 403. The comparisons are performed by computing a hash value of the concatenated text of all fields of a product. Typically, a hash value is a fixed length string that uniquely identifies such concatenation of product fields. The hash value concisely and quickly allows the server to determine if a product already existed in the previous processing phase. If even one product timestamp in a page is different from a previous processing phase (e.g. either because a new product was added or a product field value has changed), then the page and section timestamps are also updated. In this way, the catalogue application 415 is capable of receiving from the network 103 new product details for a new or modified product.

The catalogue section is stored (block 1409). It can be appreciated that each product ID is associated with a time stamp, a page ID, and a section ID. It is noted that pages and sections are also associated with a timestamp.

The data streams, for each section, are stored as a product content file (block 1410). The page layouts, for each section of the catalogue, are stored as a catalogue layout file (block 1411). This may be desired when sending an entire catalogue at once to an electronic device 105.

In an example embodiment, the data stream for a given section is stored as a separate product content file, and the corresponding page layout or page layouts for the same given section are stored as a separate layout file. This may be desired when sending a given catalogue section to the electronic device 105.

The product content file and the catalogue layout file are sent to the electronic device 105 (block 1412). In an example embodiment, both files are XML files.

Sending the layout file and the product content file as separate files takes less data than sending the compiled catalogue. This reduces the time it takes for the electronic device 105 to receive the catalogue data. However, in another example embodiment, the catalogue server compiles the layout file and the product content file to create the catalogue, and then sends the compiled pages of the catalogue to the electronic device 105.

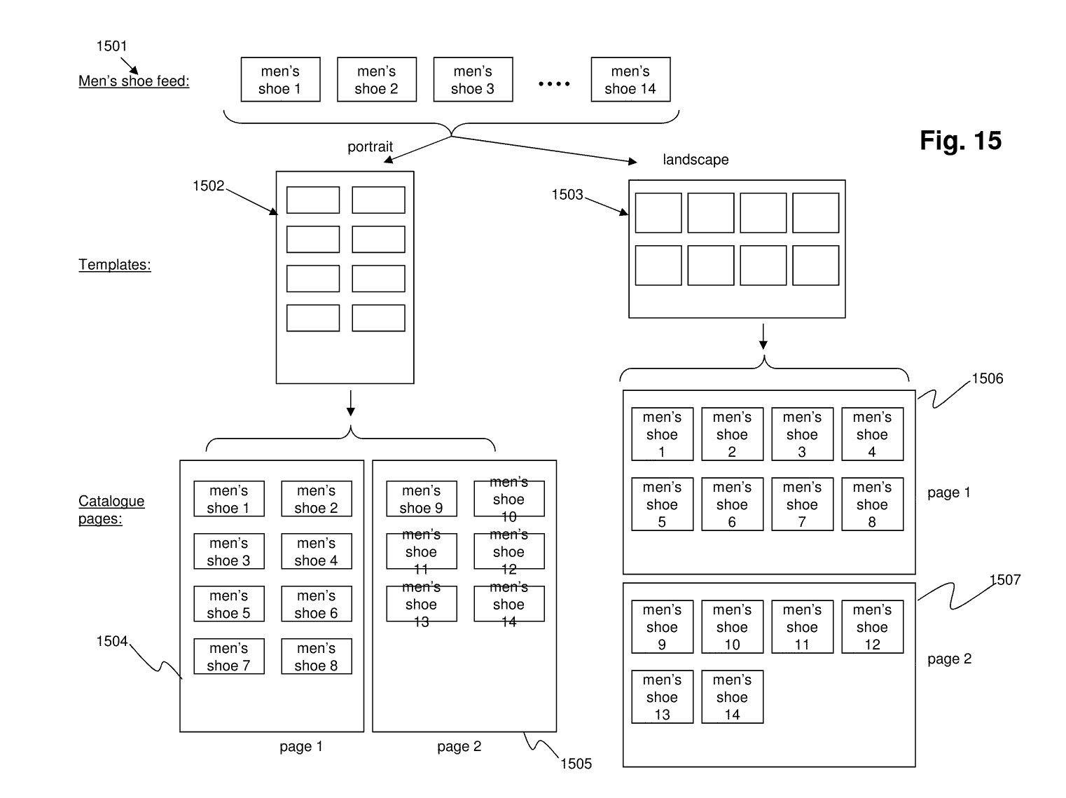

Turning to FIG. 15, an example embodiment of assigning products from a data stream (or feed) to a layout page is provided. A data stream of men's shoes 1501 includes fourteen different shoes. The selected templates, both the portrait template 1502 and the corresponding landscape template 1503, each have eight slots. Using the portrait template 1502, two portrait page layouts 1504, 1505 are created. The first page layout 1504 has eight of the fourteen shoes assigned to the product slots. The second page layout 1505 has the remaining six shoes assigned to the product slots.

Similarly, using the landscape template 1503, two landscape page layouts 1506, 1507 are created. The first page layout 1506 has eight of the fourteen shoes assigned to the product slots. The second page layout 1507 has the remaining six shoes assigned to the product slots.

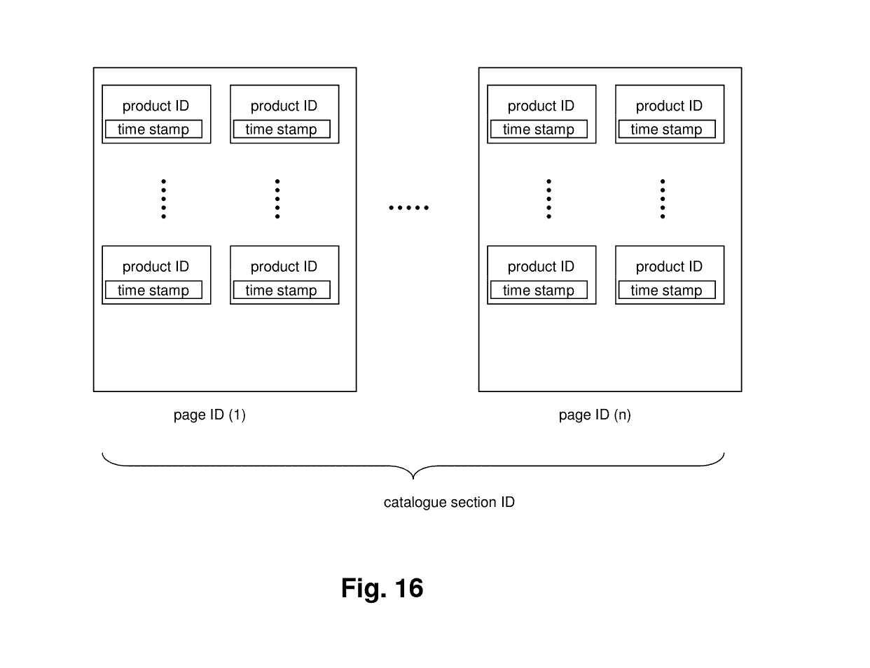

Turning to FIG. 16, an example embodiment of data components associated with each page layout is shown. Each page layout is associated with a page ID. Each page layout is also associated with a catalogue section ID. Within each page layout, there are assigned one or more product IDs to each slot (as per the template). A time stamp is also associated with each product ID.

In an example embodiment, an address pointer is used to identify the specific product in the data stream, or the product content file, that is associated with a given slot in a page layout. The address pointer can be the product ID itself, or can be another identifier. The address pointer is part of the page layout, and is associated with instructions of where to position the specified product information (e.g. image or text). In this way, when the page layout and the data stream (or product content file) are sent to the electronic device 105 as separate files, the electronic device 105 can identify which product information from the data stream should be inputted or slotted into a particular position in the page layout.

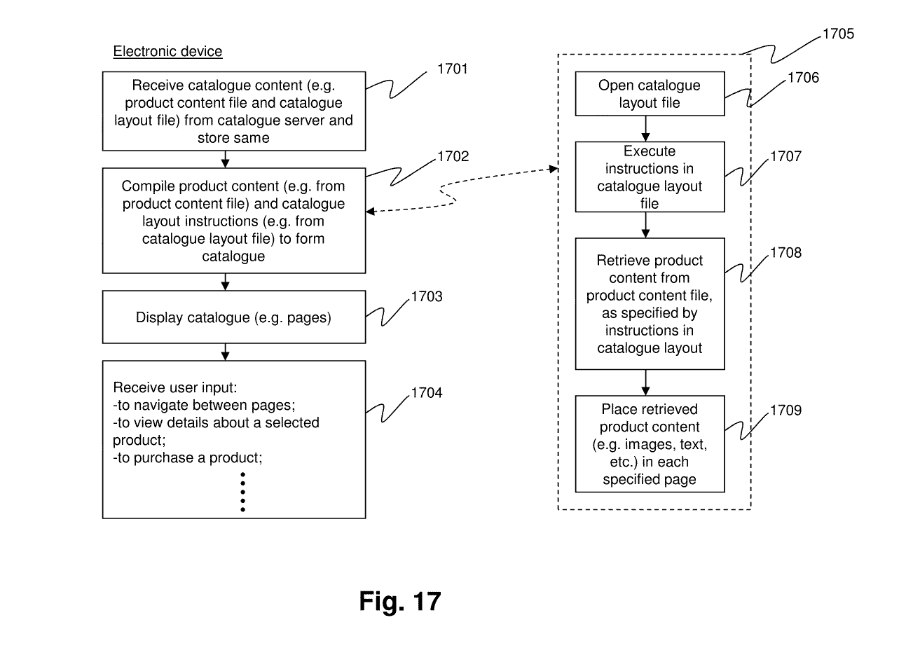

Turning to FIG. 17, an example embodiment of computer executable or processor implemented instructions is provided for an electronic device 105 displaying a catalogue. The electronic device receives the catalogue content from the catalogue server and stores the same (block 1701). The catalogue content includes the product content file and the catalogue layout file. By storing the catalogue content on the electronic device, even if the electronic device is no longer connected to the catalogue server (e.g. via Internet), then the electronic device is still able to display the catalogue to the user. For example, if the user is on an airplane or in an area without network connectivity, the user can still browse the catalogue using the electronic device 105.

The electronic device then compiles the product content and catalogue layout file to form the catalogue (block 1702). An example embodiment of such a process is described in block 1705. It includes opening the catalogue layout file (block 1706). The catalogue server executes the instructions in the catalogue layout file (block 1707). This includes retrieving product content (e.g. images and text) from the product content file (block 1708). The product content is then placed in specified positions in each page layout (block 1709). This forms a compiled page. The compiled pages may also include links for viewing a detailed description of each product, for viewing colors and sizes, and for launching a payment or purchasing session.

The compiled pages form a catalogue, and this is then displayed by electronic device (block 1703). The electronic device can receive various user inputs that allow the user to interact with the catalogue (block 1704). These inputs can be used to, for example, navigate between pages, navigate between catalogue sections, view details about a selected product, and purchase a selected product.

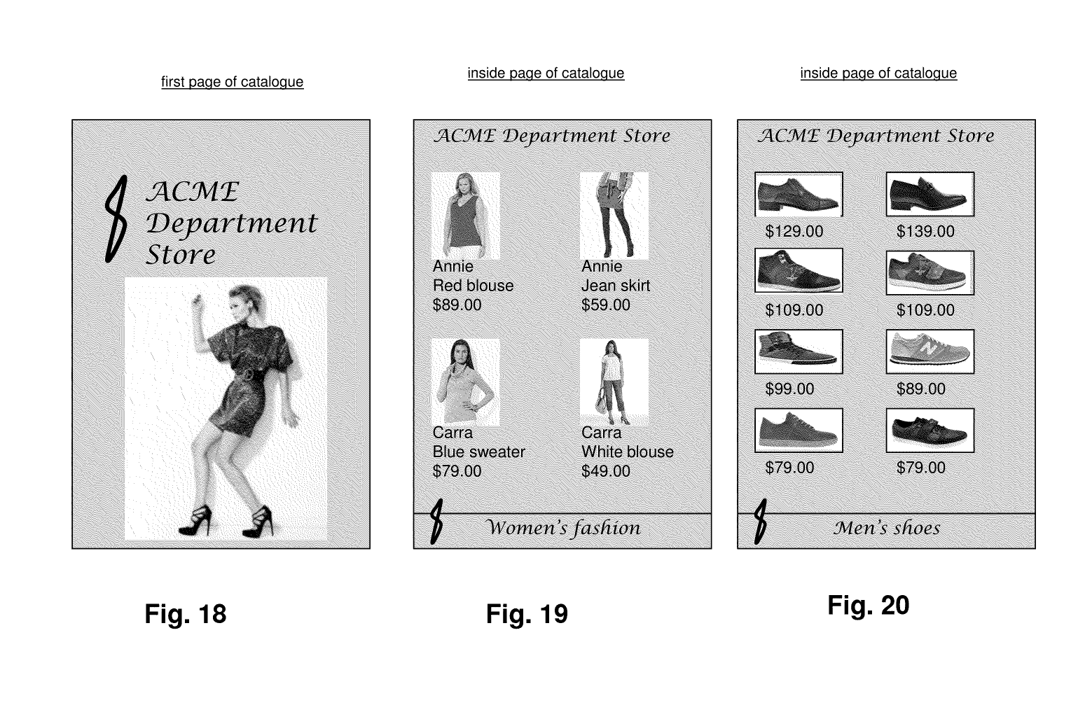

FIGS. 18, 19 and 20 show finished or compiled pages of a catalogue, as displayed on the electronic device to the user.

Turning to FIG. 18, an example embodiment of a screen shot of a cover page of a catalogue is shown. The name of the merchant and the logo of the merchant is displayed. The catalogue front page can be pre-made, or it can be configured according to a template provided by the catalogue server.

Turning to FIG. 19, an example embodiment of a screen shot of a page in a Women's Fashion section of the catalogue is shown. The screen shot includes images of women's fashion items, the name of the merchant, and the name of the catalogue section. A logo of the merchant is also shown beside the name of the catalogue section.

Turning to FIG. 20, an example embodiment of a screen shot of a page in a Men's Shoe section of the catalogue is shown. The screen shot includes images of various men's shoes, the name of the merchant, and the name of the catalogue section. A logo of the merchant is also shown beside the name of the catalogue section. It can be appreciated that the configuration of the page in FIG. 20 is different than the configuration of the page in FIG. 19. This is due to the use of a different template.

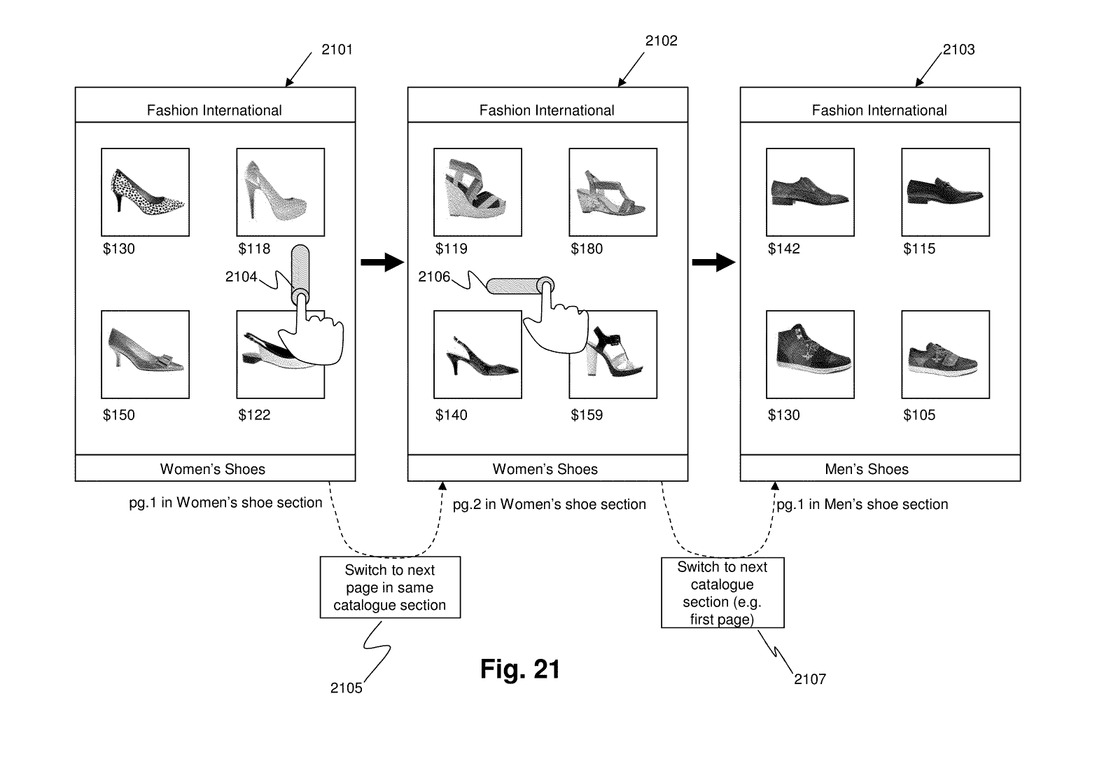

Turning to FIG. 21, an example embodiment of the GUI of the catalogue application 415 is shown. The example embodiment is to be used with an electronic device 105 that has a touch-sensitive display screen, for example on a tablet. A compiled page 2101 in the catalogue is shown by the electronic device. The page 2101 shows a first page in the women's shoes section. After the electronic device detects that a user has provided a downwards swiping touch gesture 2104 on the page 2101, the electronic device displays the next page in the same section (block 2105). In this example, the second page 2102 in the women's shoe section is displayed.

After the electronic device detects that a user has provided a sideways swiping touch gesture 2106 on the page 2102, the electronic device displays a page (e.g. the first page) in the next catalogue section (block 2107). In this example, the next catalogue section is men's shoes and the first page 2103 of that section is displayed.

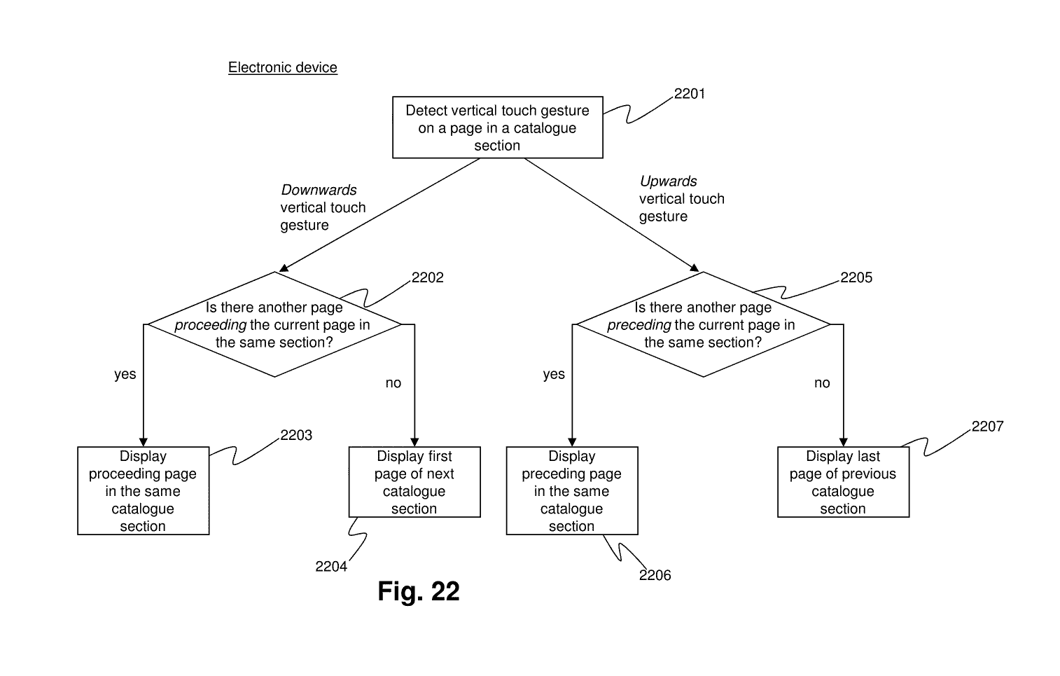

Turning to FIG. 22, an example embodiment of computer executable or processor implemented instructions is provided for navigating the catalogue based on touch gestures. The electronic device detects a vertical touch gestures on a page within a given catalogue section (block 2201). If it is determined that the touch gesture is a downwards vertical touch gesture, the electronic device determines if there is another page proceeding the current page in the same section (block 2202). If there is a proceeding page in the same catalogue section, then the proceeding page of that same section is displayed (block 2203). If there is no such proceeding page, then the first page of the next catalogue section is displayed (block 2204).

If it is determined that the touch gesture is an upwards vertical touch gesture, the electronic device determines if there is another page preceding the current page that is within the same catalogue section (block 2205). If so, the electronic device displays the preceding page (block 2206). If there is no such preceding page in the same section, then the last page of the previous catalogue section is displayed (block 2207).

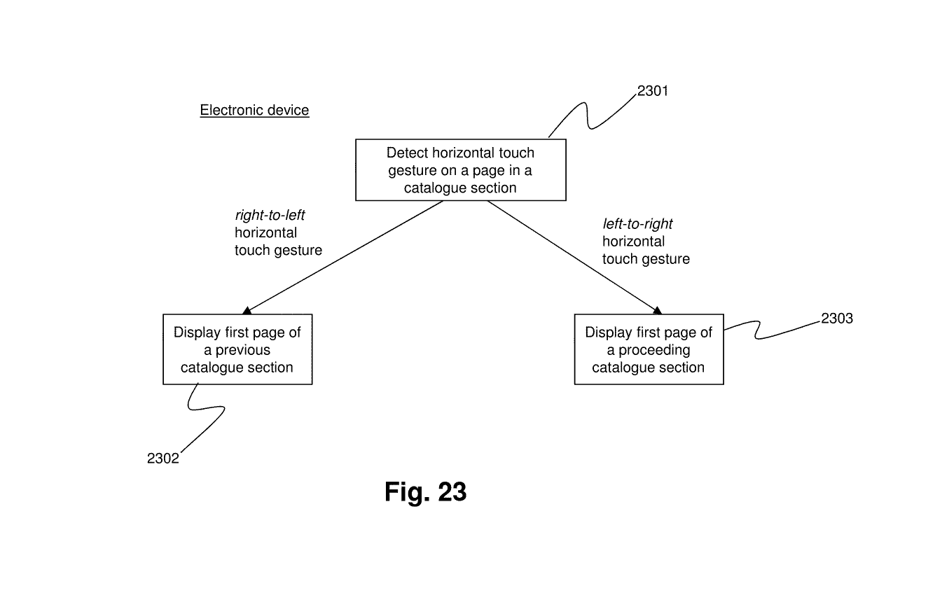

In this way, the experience of using a traditional paper catalogue is provided when flipping through pages on the electronic device. As per FIG. 23 below, the experience can be augmented by using different touch gestures to jump to a next section in the catalogue, or jump to a previous section in the catalogue.

Turning to FIG. 23, another example embodiment of computer executable or processor implemented instructions is provided for navigating the catalogue based on touch gestures. The electronic device detects a horizontal touch gesture on a page within a given catalogue section (block 2301). If the gesture is a right-to-left touch gesture, then the electronic device displays the first page of a previous catalogue section (block 2302). If the gesture is a left-to-right touch gesture, then the electronic device displays the first page of a proceeding catalogue section (block 2303).

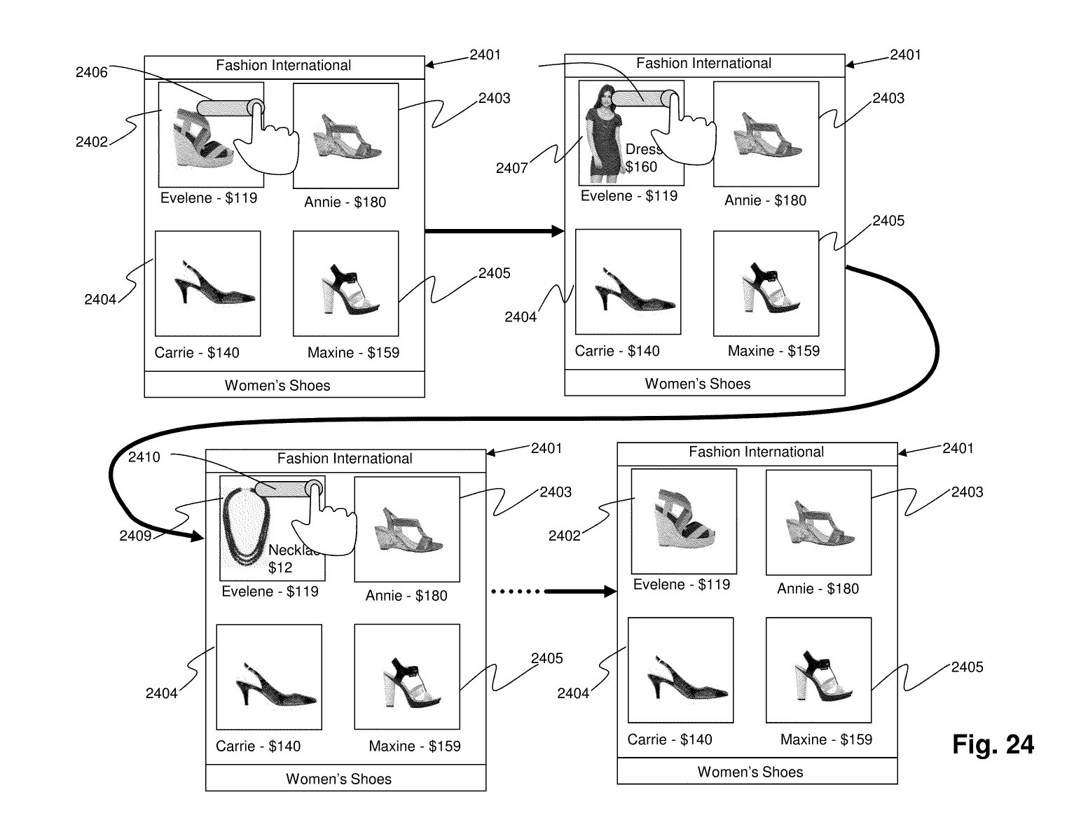

Turning to FIG. 24, an example embodiment of the GUI of the catalogue application 415 is shown. A user can view the products related to a given product by providing touch inputs to a given product. The example embodiment is to be used with an electronic device 105 that has a touch-sensitive display screen, for example on a tablet. A page 2401 in the women's shoe section of a catalogue is shown by the electronic device. Displayed on the page are four different women's shoes 2402, 2403, 2404, and 2405. After the electronic device detects a touch gesture 2406 that swipes one of products to the side (e.g. swiping the image of the shoe 2402 to the right), the product image is replaced with an image of a related product.

For example, an image of a dress 2407 is shown, because it is related to the shoes 2402. The name of the dress and the cost of the dress may also be shown. The page 2401 remains the same, and the other products 2403, 2404, and 2405 also remain the same. Only the image of the selected product has changed to show information about a related product. After the electronic device detects another sideways touch gesture 2408 over the related product 2407, yet another related product 2409 is shown in its place. The other related product is a necklace 2409. An image, name, and cost are shown. The necklace is shown because it is related to the shoes 2402. It is noted that the page 2401 in the women's shoe section does not change, even when the product information in the particular slot changes.

The user can continue swiping the images by repeating touch gesture 2410 to show any other products related to the shoe 2402. Eventually, the original shoe 2402 is shown again in the slot.

The above GUI allows a user to view products that are related to a given product without switching pages. For example, a user views a page of shoes, and the user takes a temporary interest in products related to a certain pair of shoes (e.g. other clothes that make a complete outfit). The user can use the GUI to view the related products. The page does not change while browsing the related products. If the user loses interest in the related products and wishes to continue browsing other shoes on the page or within the same section, the user can easily do so since the page has not changed.

It can be appreciated that the related products are identified using tags or information associated with the product.

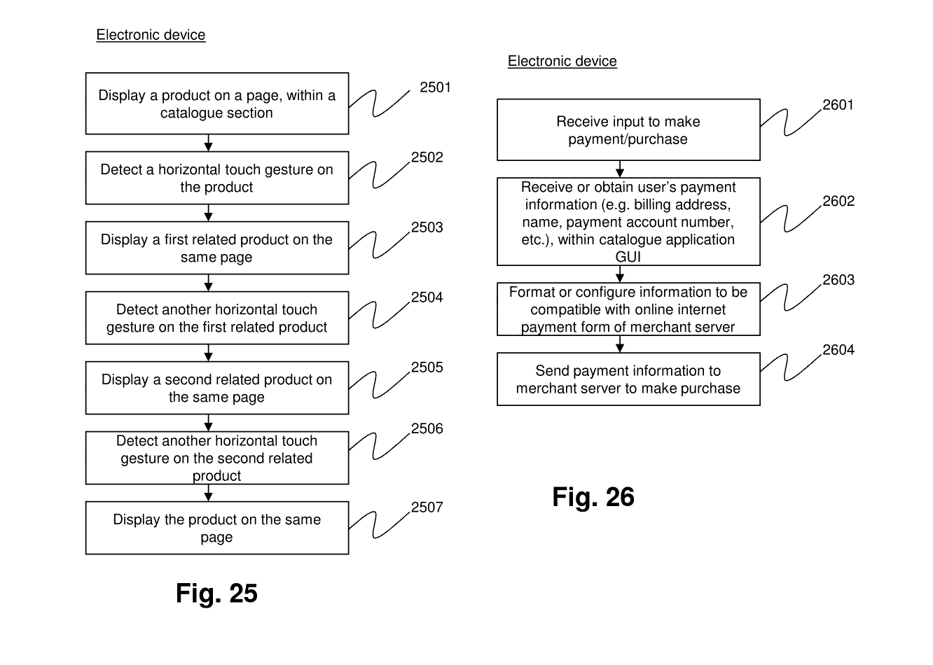

Turning to FIG. 25, an example embodiment of computer executable or processor implemented instructions is shown for navigating between related products. The electronic device displays a product on a page, within a given catalogue section (block 2501). The electronic device detects a horizontal touch gesture on the product (block 2502). The electronic device then displays a first related product on the same page (block 2503). The first related product is shown in place of the product. The electronic device detects another horizontal touch gesture on the first related product (block 2504). The electronic device displays a second related product on the same page (block 2505). The electronic device detects yet another horizontal touch gesture on the second related product (block 2506). The electronic device displays the original product on the same page (block 2507).

In a general example embodiment, displaying one or more pages on a display screen includes displaying a given product in a certain location on a given page. When the electronic device detects a user input in relation to the given product, the electronic device displays another product related to the given product. In particular, the other product is displayed in the same certain location on the same given page in place of the given product. When the same input is applied again to the other product, yet another product that is related to the given product is displayed in the same certain location. The process repeats until there are no other related products to display, such that the same input would cause the electronic device to display the given product again.

Turning to FIG. 26, an example embodiment of computer executable or processor implemented instructions is shown for making payment or purchase using the catalogue application 415. The electronic device receives an input to make payment or purchase for one or more products (block 2601). The electronic device, using the catalogue application, displays a GUI for receiving or obtaining the user's payment information (e.g. billing address, name, payment account number, etc.). The electronic device receives this information (block 2602). The electronic device formats or configures the information to be compatible with the online payment form provided by the merchant server (block 2603). It is appreciated that the merchant server has an online or Internet payment form provided on the merchant's website. The payment information received in the catalogue application is used to fill-out the merchant's online payment form. Such a procedure is hidden from the user's perspective. The user only perceives interacting with the catalogue application. At block 2604, the electronic device sends the payment information to the merchant server to make the purchase.

When making a payment, the electronic device 105 does not display the Internet browser 414. In this way, the user experience of using the interactive catalogue is more uniform. The user experience is not interrupted with the use of the GUI of the Internet browser, or the GUI of the merchant's web page.

In an example embodiment, the catalogue application automatically completes the payment form via a web browser. The payment form is provided by the merchant's website. The catalogue application accomplishes this using a number of parameters that are not shown to the final user, but that are required by the merchant server to process payment. These payment parameters are received through the network from the catalogue server and are also time stamped (e.g. associated with timestamps). The catalogue server sends the payment parameters to the mobile device. When the merchant server changes its payment formats and parameters, the catalogue application will detect the change based on the timestamp, and the catalogue application will automatically send the new parameters and formats to the mobile device to support the new payment format.

In another aspect of the methods and systems, the catalogue can be updated on the electronic device in such a way that reduces the amount of data being transferred. The catalogue on the electronic device can also be updated in such a way that reduces the amount processing used to compile the catalogue. This is achieved by changing the relevant catalogue sections, or the relevant pages, rather than the entire catalogue.

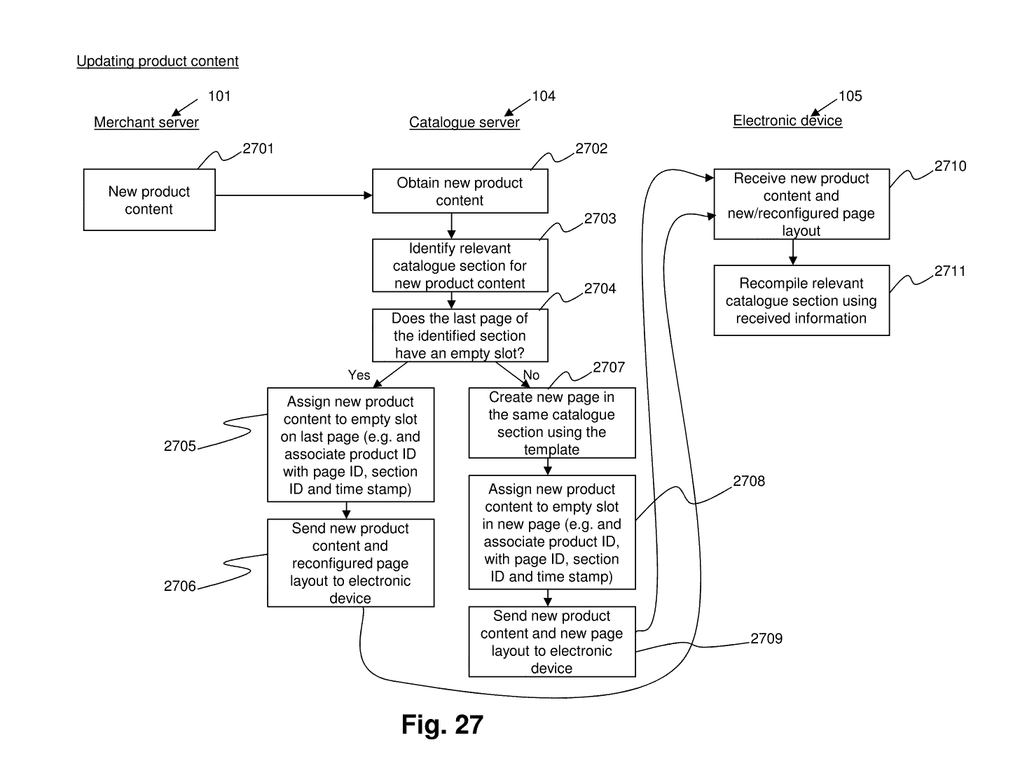

Turning to FIG. 27, an example embodiment of computer executable or processor implemented instructions is shown for updating product content. The merchant server 101 may have new product content available (block 2701). The catalogue server 104 obtains this new product content (block 27202). For example a new women's shoe is made available by the merchant. The catalogue server identifies the relevant catalogue section of the new product content (block 2703). For example, the relevant section is the women's shoe section. The catalogue server determines if the last page of the identified section has an empty slot (block 2704).

If there is an empty slot, then the new product content is assigned to the empty slot on the last page (block 2705). In doing so, the product ID of the new product content is associated with the page ID, the section ID and a time stamp.

In an example embodiment, the catalogue application on the electronic device, section and page timestamps are cached and saved locally. If upon starting a new session, the catalogue application receives new timestamps associated with sections and pages, then the catalogue application also receives the notion that a page may have changed. If so, the catalogue application identifies which product has a different timestamp compared to cached product timestamps. Such product content are downloaded anew. The other product content, that does not have different time stamps, is not downloaded into the electronic device.

The catalogue server then sends the new product content and the reconfigured page layout to the electronic device (block 2706). For example, the product content about the new women's shoe and the reconfigured last page layout (to which the new show is assigned), is sent to the electronic device.

If there is no empty slot on the last page of the identified section, then the catalogue server creates a new page in the same identified catalogue section using the corresponding template (block 2707). For example, a new page is added to the women's shoe section. The catalogue server assigns the new product content to an empty slot in the new page. In doing so, the product ID of the new product content is associated with the page ID, the section ID and a time stamp. The catalogue server then sends the new product content and the new page layout to the electronic device (block 2709).

After block 2706, or block 2709, the electronic device receives new product content and the new or reconfigured page layout (block 2710). The electronic device recompiles the relevant catalogue section using the received information (block 2711). It can be seen that the data size sent to the electronic device is relatively small. Furthermore, as the relevant catalogue section is updated, and not necessarily the entire catalogue, the electronic device consumes less processing resources to update the catalogue.

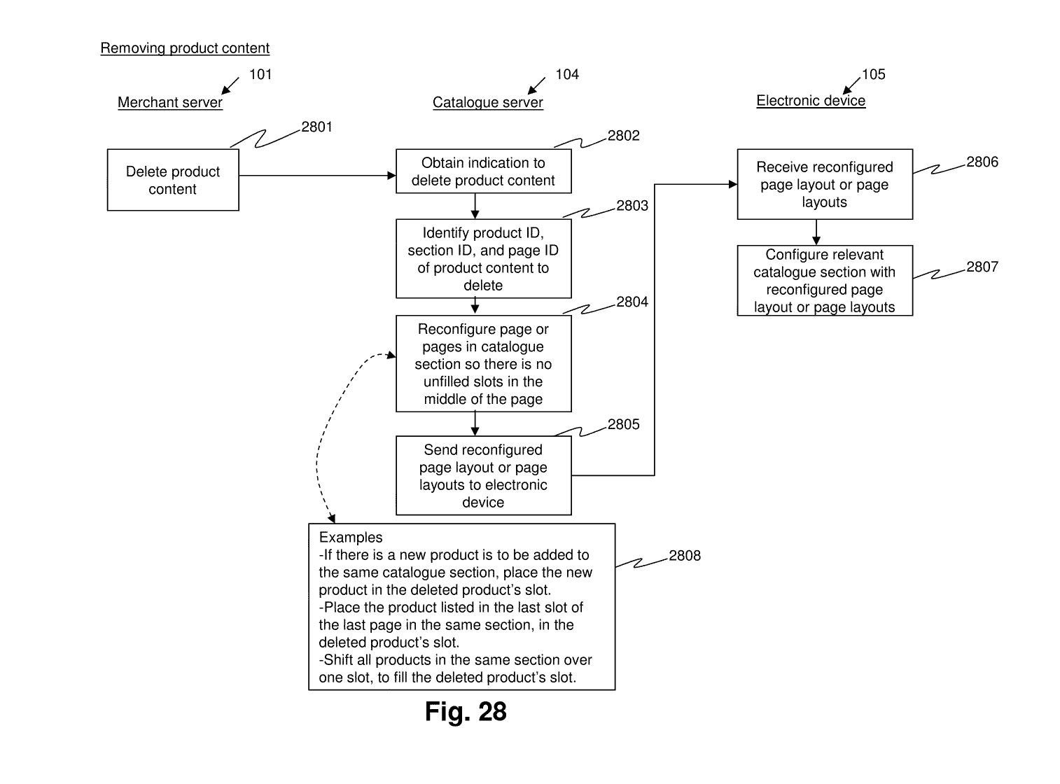

Turning to FIG. 28, an example embodiment of computer executable or processor implemented instructions is shown for removing or deleting product content. The merchant server may delete or remove product content (block 2801). For example, the merchant may discontinue selling a women's shoe item. The catalogue server obtains an indication to delete the product content (block 2802). The catalogue server may receive such an indication from the merchant server. In another example, the catalogue server detects such an indication by comparing a previous list of products sold by the merchant with a new list of products sold by the merchant. The catalogue server identifies the product ID, section ID, and page ID that corresponds to the product content to be deleted (block 2803). The catalogue server reconfigures a page layout or page layouts in the relevant catalogue section so there is no unfilled slot in the middle of the page (block 2804). For example, if the women's shoe to be deleted is positioned in a slot located in the middle of the page, it would be aesthetically unpleasing to simply remove the women's shoe. This would create a “hole” or “blank” in the middle of the page. Although this could be done, it is not preferred.

At block 2808, example embodiments for ensuring there are no unfilled slots in the middle of the page are provided. If the catalogue server also detects that there is a new product to be added to the same catalogue section, then the new product is placed in the deleted product's slot. In another example, the product that is listed in the last slot on the last page of the same section is moved and placed in the deleted product's slot. In another example, all products in the same section are shifted over one slot to fill in the deleted product's slot. It can be appreciated that one or more page layouts can be affected.

Continuing with FIG. 28, at block 2805, the catalogue server sends the reconfigured page layout or page layouts to the electronic device.

The electronic device receives the reconfigured page layout or page layouts (block 2806). The electronic device configures the relevant catalogue section with reconfigured page or page layouts (block 2807). In this way, product content in the catalogue can be updated with exchanging a lower amount of data, and using less computing resources.

In a general example embodiment, a method performed by a computing device for providing a catalogue includes: obtaining data about multiple products, the data comprising at least an image and text associated with each product; grouping the data into multiple data streams, each stream associated with a product section of the catalogue; identifying a page template associated with a given data stream; creating one or more page layouts by assigning the data of each product, from the given data stream, into certain positions in the associated page template; and providing the one or more page layouts and the given data stream, wherein the one or more page layouts and the given data stream are configured to form a given product section of the catalogue.

In an aspect of the example embodiment, the text associated with each product includes a product ID, a product name, and a product category.

In another aspect, the method further includes: when a word is found in the text associated with a given product and the word matches any one of a plurality of words grouped together under a heading, wherein each one of the plurality of words is associated with the heading, adding the heading as a tag to the product.

In another aspect, the tag identifies at least one a product category, a product name, and a brand name of the given product.

In another aspect, each data stream is identified by a section ID, and the given product section is based on any one of a product category and a brand name.

In another aspect, the data is RSS data and multiple data streams are RSS feeds.

In another aspect, obtaining the data about the multiple products includes obtaining non-RSS data about the multiple products and converting the non-RSS data into RSS data.

In another aspect, identifying the page template associated with the given data stream includes: determining that a predetermined mapping between data stream information and the page template applies to the given data stream when the data stream information of the predetermined mapping matches data stream information of the given data stream; and identifying the page template from the mapping is associated with the given data stream.

In another aspect, a page template includes at least one product slot, each product slot having a predetermined location on the page template and configured to receive and display the image and the text associated with a given product.

In another aspect, the method includes computing a number of page layouts to be created by at least: dividing n, which represents a number of the multiple products, by a number of product slots in the page template to obtain a quotient; and if there is a remainder from the division computation, incrementing the quotient by one to obtain the number of page layouts; otherwise using the quotient as the number of page layouts.

In another aspect, the one or more page layouts and the given data stream are configured to be compiled together by an electronic device.

In another general example embodiment, a method performed by an electronic device for providing a catalogue, includes: obtaining one more page layouts and an associated data stream, the data stream comprising data about multiple products, the data comprising at least an image and text associated with each product, the one or more page layouts including instructions to display certain images and text in certain locations; compiling one or more pages corresponding respectively to the one or more page layouts; and displaying the one or more pages on a display screen of the electronic device.

In an aspect of the example embodiment, the associated data stream is associated with a product section of the catalogue, and the one or more pages are compiled to form the product section of the catalogue.

In another aspect, a given page layout includes at least one product slot, and a given product slot has a predetermined location on the given page layout and the product slot is associated with an image and text of a given product.

In another aspect, compiling the one or more pages corresponding respectively to the one or more page layouts includes: using an address pointer within the given page layout to identify the given product in the data stream; and inputting the image and text associated with the given product into the given slot to compile a given page.

In another aspect, the address pointer is a product ID, which is associated with the given product slot.

In another aspect, the associated data stream is an RSS feed.

In another aspect, displaying the one or more pages on the display screen of the electronic device further includes displaying a given product in a certain location on a given page; and the method further includes: detecting a user input in relation to the given product; and displaying another product related to the given product, the other product displayed in the certain location on the same given page in place of the given product.

In another general example embodiment, a computing device includes: a processor; and a memory device. The memory device includes executable instructions for providing a catalogue, the executable instructions including: obtaining data about multiple products, the data including at least an image and text associated with each product; grouping the data into multiple data streams, each stream associated with a product section of the catalogue; identifying a page template associated with a given data stream; creating one or more page layouts by assigning the data of each product, from the given data stream, into certain positions in the associated page template; and providing the one or more page layouts and the given data stream, wherein the one or more page layouts and the given data stream are configured to form a given product section of the catalogue.

In another general example embodiment, an electronic device includes: a processor; a display screen; and a memory device. The memory device includes executable instructions for providing a catalogue, the executable instructions including: obtaining one more page layouts and an associated data stream, the data stream comprising data about multiple products, the data comprising at least an image and text associated with each product, the one or more page layouts including instructions to display certain images and text in certain locations; compiling one or more pages corresponding respectively to the one or more page layouts; and displaying the one or more pages on a display screen of the electronic device.

The steps or operations in the flow charts and the description are just for example. There may be many variations to these steps or operations. For instance, the steps may be performed in a differing order, or steps may be added, deleted, or modified.

The GUIs and screen shots described herein are just for example. There may be variations to the graphical and interactive elements. For example, such elements can be positioned in different places, or added, deleted, or modified.

It will be appreciated that the particular example embodiments shown in the figures and described above are for illustrative purposes only and many other variations can be used according to the example embodiments described. Although the above has been described with reference to certain specific example embodiments, various modifications thereof will be apparent to those skilled in the art.

1. A method performed by a computing device for providing a catalogue, comprising:
obtaining data about multiple products, the data comprising at least an image and text associated with each product;
grouping the data into multiple data streams, each stream associated with a product section of the catalogue;
identifying a page template associated with a given data stream;
creating one or more page layouts by assigning the data of each product, from the given data stream, into certain positions in the associated page template; and
providing the one or more page layouts and the given data stream, wherein the one or more page layouts and the given data stream are configured to form a given product section of the catalogue.

2. The method of claim 1 wherein the text associated with each product comprises a product ID, a product name, and a product category.

3. The method of claim 1 further comprising: when a word is found in the text associated with a given product and the word matches any one of a plurality of words grouped together under a heading, wherein each one of the plurality of words is associated with the heading, adding the heading as a tag to the product.

4. The method of claim 3 wherein the tag identifies at least one a product category, a product name, and a brand name of the given product.

5. The method of claim 1 wherein each data stream is identified by a section ID, and the given product section is based on any one of a product category and a brand name.

6. The method of claim 1 wherein the data is RSS data and multiple data streams are RSS feeds.

7. The method of claim 1 wherein obtaining the data about the multiple products comprises obtaining non-RSS data about the multiple products and converting the non-RSS data into RSS data.

8. The method of claim 1 wherein identifying the page template associated with the given data stream comprises: determining that a predetermined mapping between data stream information and the page template applies to the given data stream when the data stream information of the predetermined mapping matches data stream information of the given data stream; and identifying the page template from the mapping is associated with the given data stream.

9. The method of claim 1 wherein a page template comprises at least one product slot, each product slot having a predetermined location on the page template and configured to receive and display the image and the text associated with a given product.

10. The method of claim 9 further comprising computing a number of page layouts to be created by at least: dividing n, which represents a number of the multiple products, by a number of product slots in the page template to obtain a quotient; and if there is a remainder from the division computation, incrementing the quotient by one to obtain the number of page layouts; otherwise using the quotient as the number of page layouts.

11. The method of claim 1 wherein the one or more page layouts and the given data stream are configured to be compiled together by an electronic device.

12. A method performed by an electronic device for providing a catalogue, comprising:
obtaining one more page layouts and an associated data stream, the data stream comprising data about multiple products, the data comprising at least an image and text associated with each product, the one or more page layouts including instructions to display certain images and text in certain locations;
compiling one or more pages corresponding respectively to the one or more page layouts; and
displaying the one or more pages on a display screen of the electronic device.

13. The method of claim 12 wherein the associated data stream is associated with a product section of the catalogue, and the one or more pages are compiled to form the product section of the catalogue.

14. The method of claim 12 wherein a given page layout comprises at least one product slot, and a given product slot has a predetermined location on the given page layout and the product slot is associated with an image and text of a given product.

15. The method of claim 14 wherein compiling the one or more pages corresponding respectively to the one or more page layouts comprises: using an address pointer within the given page layout to identify the given product in the data stream; and
inputting the image and text associated with the given product into the given slot to compile a given page.

16. The method of claim 15 wherein the address pointer is a product ID, which is associated with the given product slot.

17. The method of claim 12 wherein the associated data stream is an RSS feed.

18. The method of claim 12 wherein displaying the one or more pages on the display screen of the electronic device further comprises displaying a given product in a certain location on a given page; and the method further comprises:
detecting a user input in relation to the given product; and
displaying another product related to the given product, the other product displayed in the certain location on the same given page in place of the given product.

19. A computing device comprising:
a processor;
a memory device; and
wherein the memory device comprises executable instructions for providing a catalogue, the executable instructions comprising:
obtaining data about multiple products, the data comprising at least an image and text associated with each product;
grouping the data into multiple data streams, each stream associated with a product section of the catalogue;
identifying a page template associated with a given data stream;
creating one or more page layouts by assigning the data of each product, from the given data stream, into certain positions in the associated page template; and
providing the one or more page layouts and the given data stream, wherein the one or more page layouts and the given data stream are configured to form a given product section of the catalogue.

20. An electronic device comprising:
a processor;
a display screen;
a memory device; and
wherein the memory device comprises executable instructions for providing a catalogue, the executable instructions comprising:
obtaining one more page layouts and an associated data stream, the data stream comprising data about multiple products, the data comprising at least an image and text associated with each product, the one or more page layouts including instructions to display certain images and text in certain locations;
compiling one or more pages corresponding respectively to the one or more page layouts; and
displaying the one or more pages on a display screen of the electronic device.
